(19) United States
(12) Patent Application Publication
(10) Pub. No.: US 2024/0383204 A1
(43) Pub. Date: Nov. 21, 2024

(54) 3D PART DIGITAL MODELS WITH DIGITAL TILES

(71) Applicant: Hewlett-Packard Development Company, L.P., Spring, TX (US)

(72) Inventors: Carolina HERBSTER MESQUITA JORGE, Porto Alegre (BR); Scott WHITE, Boise, ID (US); Craig Peter SAYERS, Palo Alto, CA (US); José Clemilson DE OLIVEIRA LUCIO, Porto Alegre (BR); Henrique DE ALBUQUERQUE VASCONCELOS SOARES, Porto Alegre (BR); Joao Vianey BATISTA MOREIRA FILHO, Porto Alegre (BR)

(21) Appl. No.: 18/272,581

(22) PCT Filed: Jan. 29, 2021
(86) PCT No.: PCT/US2021/015873

§ 371 Date: Jul. 16, 2023

(51) Int. Cl. B29C 64/386; B33Y 50/00; G06T 19/20

(52) U.S. Cl. CPC B29C 64/386; B33Y 50/00; G06T 19/20; G06T 2219/2021

(57) ABSTRACT

According to examples, machine-readable instructions may cause a processor to access a digital model of a 3D part and modify the digital model to add a recess to the digital model, in which the recess corresponds to a cutout to be formed in the 3D part. The processor may also identify content to be added to the 3D part, in which the content is to be visible on the 3D part, and may access a set of digital tiles corresponding to the identified content. The processor may further add the accessed set of digital tiles corresponding to the identified content into the recess in the digital model and may generate a digital representation of the modified digital model and the added set of digital tiles, in which the digital representation may maintain the added set of digital tiles and the digital model as separately meshed elements.

### BACKGROUND

Parts may be fabricated with engraved labels for tracking purposes or to prevent counterfeiting. The engraved labels may include text and/or symbols. For instance, the engraved labels may include human-readable information and/or machine-readable information, such as in the form of barcodes or QR codes.

### BRIEF DESCRIPTION OF DRAWINGS

Features of the present disclosure are illustrated by way of example and not limited in the following figure(s), in which like numerals indicate like elements, in which:

FIG. 1 shows a block diagram of an example computer-readable medium that may have stored thereon computer-readable instructions for generating a digital representation of a 3D part and a set of digital tiles added to a recess in the digital model, in which the set of digital tiles and the digital model are maintained as separately meshed elements;

FIG. 2 depicts an example apparatus that may include the example computer-readable medium depicted in FIG. 1;

FIGS. 3A-3D respectively, depict diagrams of example elements shown in FIG. 2; and

FIG. 4 depicts a flow diagram of an example method for generating a digital representation of a digital model and an added set of digital tiles in a recess of the digital model.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are computer-readable media, methods, and apparatuses that may add digital tiles to a digital model of a three-dimensional (3D) part, in which the digital tiles may include characters that are to be visible on a fabricated 3D part. Particularly, the characters may be text, symbols, and/or the like and may denote any of various types of information. For instance, the characters may denote a serial number, a batch number, a date, and/or the like. Each of the digital model and the digital tiles may be a respective set of computer-readable instructions such as a computer-aided design (CAD) file, a print-ready file (such as a 3D manufacturing format (3MF) file), and/or the like.

In accordance with features of the present disclosure, a processor may modify the digital model of the 3D part to add a recess to the digital model. The processor may also process, e.g., generate a mesh representation of, the modified digital model such that the modified digital model may be in a print-ready format. The processor may further identify content to be added to the 3D part and may access a set of digital tiles that include characters that correspond to the characters in the identified content. The processor may add the accessed set of digital tiles into the recess in the modified digital model and may generate a digital representation of the modified digital model and the added set of digital tiles. The processor may generate the digital representation such that the digital representation maintains the added set of digital tiles and the digital model as separately meshed elements, e.g., separate mesh representations. In other words, the processor may not apply another operation, e.g., a meshing operation, on the generated digital representation to make the digital representation be in a print-ready format as the digital representation may already be in a print-ready format.

The processor may additionally re-use the modified digital model of the 3D part to generate additional digital representations that may include the modified digital model and sets of digital tiles that include other information. That is, the processor may identify other content to be added to another 3D part and may add a set of digital tiles corresponding to the other content into the recess of the modified digital model. The processor may also generate another digital representation of the modified digital model with the other set of digital tiles. By re-using the modified digital model for additional digital representations in this manner, the processor may generate the additional digital representations without having to process, e.g., generate a mesh representation, or the like, the modified digital model for each of the additional digital representations.

A technical improvement afforded by the present disclosure may thus be that processing resources as well as storage space may be reduced and/or minimized. The reduction and/or minimization of the storage space may also result in reduced or minimized bandwidth usage in communicating the generated digital representations. In addition, by reducing the number of times that the digital model is meshed, potential errors that may be introduced during meshing of the digital model may be reduced or minimized.

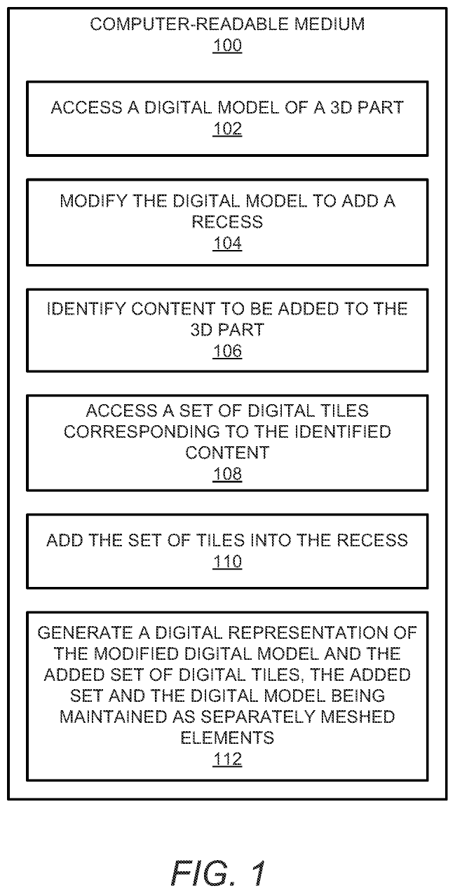

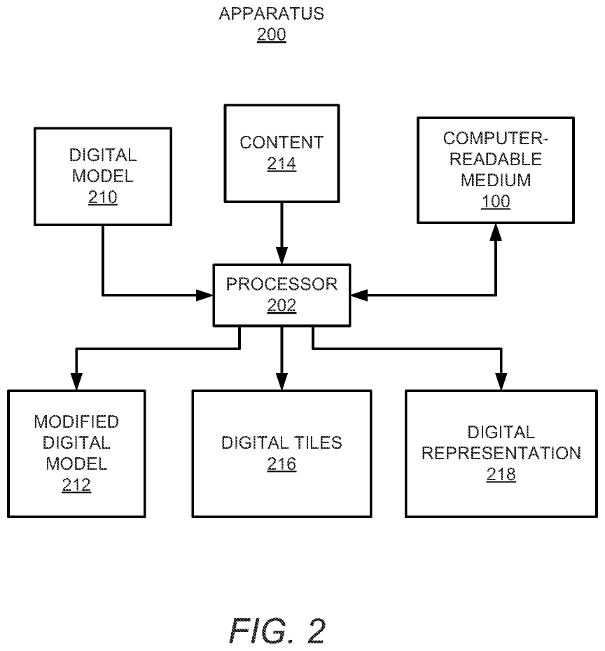

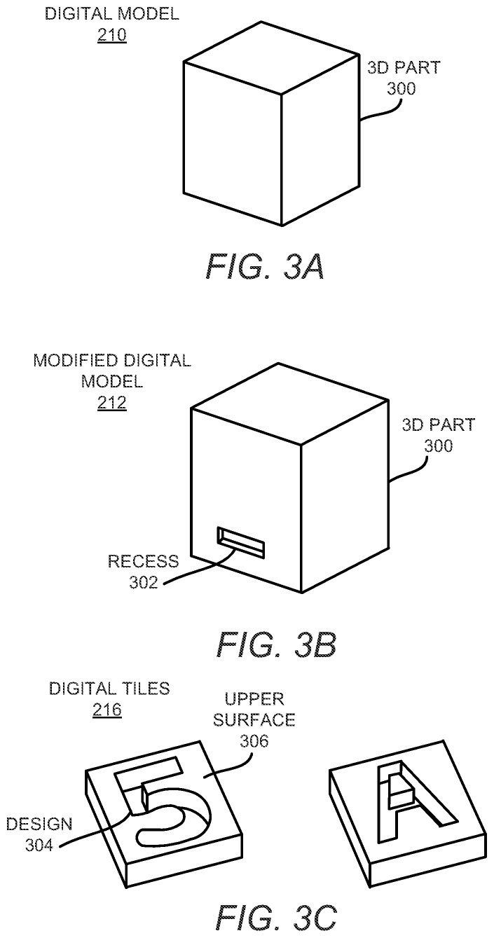

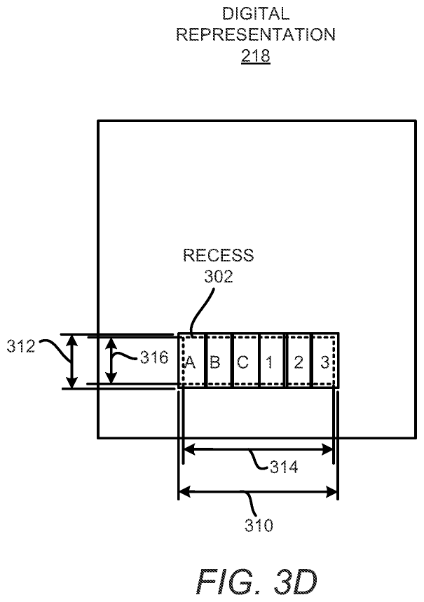

Reference is first made to FIGS. 1-3. FIG. 1 shows a block diagram of an example computer-readable medium 100 that may have stored thereon computer-readable instructions for generating a digital representation of a 3D part and a set of digital tiles added to a recess in the digital model, in which the set of digital tiles and the digital model are maintained as separately meshed elements. As discussed herein, a 3D fabrication system may fabricate the 3D part with the set of digital tiles embedded in a recess of the 3D part without, for instance, a separate meshing operation being performed on the digital representation. FIG. 2 depicts an example apparatus 200 that may include the example computer-readable medium 100 depicted in FIG. 1. FIGS. 3A-3D, respectively, depict diagrams of example elements shown in FIG. 2. It should be understood that the computer-readable medium 100, the apparatus 200, and/or the elements shown in FIGS. 3A-3D may include additional features and that some of the features described herein may be removed and/or modified without departing from the scopes of the computer-readable medium 100, the apparatus 200, and/or the elements depicted in FIGS. 3A-3D discussed herein.

According to examples, the apparatus 200 may be a computing device, such as a desktop computer, a laptop computer, a tablet computer, a server computer, and/or the like. In other examples, the apparatus 200 may be part of a 3D fabrication system, such as a controller of the 3D fabrication system. In any of these examples, the apparatus 200 may include a processor 202 that may control operations of the apparatus 200 and a computer-readable medium 100 on which data that the processor 202 may access and/or may execute may be stored. The processor 202 may be a semiconductor-based microprocessor, a central processing unit (CPU), an application specific integrated circuit (ASIC), a field-programmable gate array (FPGA), and/or other hardware device.

The computer-readable medium 100 may be an electronic, magnetic, optical, or other physical storage device that contains or stores executable instructions. The computer-readable medium 100, which may also be termed a computer readable medium, may be, for example, a Random Access memory (RAM), an Electrically Erasable Programmable Read-Only Memory (EEPROM), a storage device, an optical disk, or the like. The computer-readable medium 100 may be a non-transitory computer readable storage medium, where the term “non-transitory” does not encompass transitory propagating signals. In any regard, the computer-readable medium 100 may have stored thereon machine-readable instructions that the processor 202 may execute.

Although the apparatus 200 is depicted as having a single processor 202, it should be understood that the apparatus 200 may include additional processors and/or cores without departing from a scope of the apparatus 200. In this regard, references to a single processor 202 as well as to a single computer-readable medium 100 may be understood to additionally or alternatively pertain to multiple processors 202 and multiple computer-readable mediums 100. In addition, or alternatively, the processor 202 and the computer-readable medium 100 may be integrated into a single component, e.g., an integrated circuit on which both the processor 202 and the computer-readable medium 100 may be provided. In addition, or alternatively, the operations described herein as being performed by the processor 202 may be distributed across multiple apparatuses 200 and/or multiple processors 202.

The computer-readable medium 100 may have stored thereon computer-readable instructions 102-112 that a processor, such as the processor 202 depicted in FIG. 2, may execute. As shown in FIGS. 1 and 2, the computer-readable medium 100 may include instructions 102 that may cause a processor 202 to access a digital model 210 (FIG. 3A) of a 3D part 300. It should be understood that the 3D part 300 is depicted in FIG. 3 as having a cubic shape for purposes of illustration and thus, the present disclosure should not be construed as being limited to the features depicted in that figure.

The digital model 210 may be, for instance, a set of computer-readable instructions such as a computer-aided design (CAD) file, a print-ready file (such as a 3D manufacturing format (3MF) file), and/or the like. In any regard, the processor 202 may access the digital model 210 from a local data store (not shown), from a remote data store (not shown), from a user, and/or the like.

The computer-readable medium 100 may also include instructions 104 that may cause the processor 202 to modify the digital model 210 to add a recess 302 (FIG. 3B) to the digital model 210. The recess 302 may correspond to a cutout to be formed in the 3D part 300. The computer-readable medium 100 may further include instructions 106 that may cause the processor 202 to identify content 214 that is to be added to the 3D part 300, in which the content 214 is to be visible on the 3D part 300 when the 3D part 300 is fabricated. The content 214 may be machine-readable data, such as a barcode, a quick response (QR) code, and/or the like. In addition, or alternatively, the content 214 may be human-readable data, such as text, numerals, logos, symbols, and/or the like.

According to examples, the processor 202 may modify the digital model 210 to include a recess 302 that is of a standard size, while in other examples, the processor 202 may modify the digital model 210 to include a recess 302 that corresponds to the size, e.g., length, depth, and/or width, of the content 214. Particularly, and as discussed in greater detail herein, the recess 302 may be sized to be a slightly smaller than the digital tiles corresponding to the content 214.

The processor 202 may also process, e.g., mesh, or the like, the modified digital model 212 such that a 3D fabrication system may fabricate (or equivalently, print) the 3D part 300 based on the modified digital model 212. In other words, the processor 202 may mesh or perform another operation on the modified digital model 212 to cause the modified digital model 212 to be in a print-ready format. A 3D fabrication system may thus print the 3D part 300 using the modified digital model 212 without the 3D fabrication system further processing, e.g., meshing, or the like, the modified digital model 212.

The computer-readable medium 100 may also include instructions 108 that may cause the processor 202 to access a set of digital tiles 216 that correspond to the identified content 214. Some or all of the digital tiles 216 may include a respective design 304, which may be a character, symbol, logo, and/or the like. The example digital tiles 216 depicted in FIG. 3C are depicted as including designs 304 that are a number and a letter for purposes of illustration. In addition, the designs 304 are depicted as being engravings in the digital tiles 216 and thus extending into the interiors of the digital tiles 216. In other examples, the designs 304 may be embossed on the digital tiles 216 and may thus extend above an upper surface 306 of the digital tiles 216. In addition, or in other examples, the designs 304 may be portions of the digital tiles 216 having a color that differs from the areas surrounding the portions, and in some implementations, the portions may be co-planar with the areas surrounding the portions.

The digital tiles 216 (FIG. 3C) may be respective sets of computer-readable instructions such as a computer-aided design (CAD) files, print-ready files (such as a 3D manufacturing format (3MF) file), and/or the like. That is, for instance, the digital tiles 216 may each be or may include files in which the digital tiles 216 have been processed, e.g., meshed, such that a 3D fabrication system may use the digital tiles 216 to fabricate (or equivalently, print) physical tiles corresponding to the digital tiles 216. In other words, the digital tiles 216 may be in a format that the 3D fabrication system may print the physical tiles using the digital tiles 216 without the digital tiles 216 having to be further processed, e.g., meshed, or the like, to be in a print-ready format for the 3D fabrication system.

According to examples, the processor 202 may access the digital tiles 216 from a library in a local data store (not shown), in a remote data store (not shown), and/or the like. That is, for instance, a plurality of various digital tiles 216 may have previously been generated and may be stored in a library that the processor 202 may access. The digital tiles 216 may include designs 304 corresponding to various combinations of the content 214 that may be added to 3D parts 300. In some examples, the digital tiles 216 may all have the same dimensions while in other examples, some groups of the digital tiles 216 may have dimensions that differ from other groups of the digital tiles 216. In some examples in which the digital tiles 216 may not have appropriate dimensions to fit within the recess 302, the processor 202 may scale the digital tiles 216 to fit within the recess 302. The processor 202 may scale the digital tiles 216 without having to process, e.g., mesh, or the like, the digital tiles 216 again after the digital tiles 216 have been scaled. The processor 202 may also apply colors to the digital tiles 216, for instance, to match the color of the location of the digital model 210 at which the digital tiles 216 are to be added.

According to examples, the library may store groups of digital tiles 216 that may be suited for various positions within the recess 302. For instance, the library may store a first group of digital tiles 216 that may be suited for a first, left-most location within the recess 302, a second group of digital tiles 216 that may be suited for middle locations within the recess 302, and a third group of digital tiles 216 that may be suited for the right-most location within the recess 302. In these examples, the first group of digital tiles 216 may have a different property with respect to the other groups of digital tiles 216. For instance, the first group of digital tiles 216 may have a different tile geometry, a different font, a different sized font, capitalized letters, different sized designs, and/or the like, with respect to the other groups of digital tiles 216.

The computer-readable medium 100 may further include instructions 110 that may cause the processor 202 to add the accessed set of digital tiles 216 corresponding to the identified content 214 into the recess 302 in the digital model 210. The processor 202 may insert the digital tiles 216 into the recess 302 as shown in the digital representation 218 in FIG. 3D. According to examples, the digital tiles 216 and the recess 302 may have similar depths such that the digital tiles 216 may be relatively flush with the digital model 210. In some examples, a user may specify the depths of the digital tiles 216 and/or the recess 302.

As also shown in FIG. 3D, the set of digital tiles 216 may have a first width 310 and a first height 312 and the recess 302 may have a second width 314 and a second height 316. The first width 310 of the set of digital tiles 216 may be slightly larger (e.g., within about 0.001 and about 0.5 mm) than the second width 314 of the recess 302 and the first height 312 of the set of digital tiles 216 may be slightly larger than the second height 316 of the recess 302. Similarly, the set of digital tiles 216 may have a depth that is slightly larger than a depth of the recess 302. In this regard, the set of digital tiles 216 may be relatively larger than the recess 302 such that, when the 3D part 300 is previewed or fabricated, there may be overlap between the digital tiles 216 and the 3D part 300 and the digital tiles 216 may be integrated with the 3D part 300. In other examples, however, the processor 202 may arrange the digital tiles 216 within the recess 302 such that the digital tiles 216 may abut the sides of the recess 302, e.g., with no overlap.

In order to ensure that there are dimensional differences between the digital tiles 216 and the recess 302, the processor 202 may modify the digital model to add the recess 302 to have a second height 316 and a second width 314 such that the second height 316 is smaller than the first height 312 of the set of digital tiles 216 and the second width 314 is smaller than the first width 310 of the set of digital tiles 216. Alternatively, the processor 202 may modify the set of digital tiles 216 to have the first height 312 and the first width 310 such that the first height 312 is larger than the second height 316 of the recess 302 and the first width 310 is larger than the second width 314 of the recess 302.

In addition, the processor 202 may arrange the digital tiles 216 within the recess 302 such that edges of adjacent ones of the digital tiles 216 may overlap each other. The amount of overlap may be, for instance, within about 0.001 and about 0.5 mm. In this regard, when the 3D part 300 is fabricated, the digital tiles 216 may be fabricated to be integrated with each other. In other examples, however, the processor 202 may arrange the digital tiles 216 within the recess 302 such that adjacent ones of the digital tiles 216 may abut each other, e.g., with no overlap.

In some examples, the processor 202 may access a first digital tile 216 corresponding to a first character in the content 214 from a first group of digital tiles 216 and may access a second digital tile 216 corresponding to a second character in the content 214 from a second group of digital tiles 216. In these examples, the digital tiles 216 in the first group of digital tiles 216 may include digital tiles 216 that have properties that differ from properties of the digital tiles 216 in the second group of digital tiles 216. For instance, the first group of digital tiles 216 may be larger, upper-case, and/or the like, and the second group of digital tiles 216 may be smaller, lower-case, and/or the like. As another example, the first group of digital tiles 216 may have a dimension, e.g., width, that differs from a comparable dimension of the second group of digital tiles 216. As a yet further example, the first group of digital tiles 216 may have a design that differs from the second group of digital tiles 216.

In some instances, such as when the digital model 210 already includes a recess 302, the recess 302 may be relatively larger than the set of digital tiles 216. In these instances, a transition area, such as a gap, may exist between a digital tile 216 in the recess 302 and a portion of the recess 302. In some examples, the processor 202 may modify at least one of the digital tile 216 and the 3D part 300 to reduce or minimize a sharpness of the transition area, for instance, by minimizing the gap. This may include, for instance, the enlargement of the digital tile 216, the addition of another digital tile 216, or the like, to minimize or eliminate the gap. By way of example, the processor 202 may add a digital tile 216 or a block that does not include design.

In some instances, the recess 302 in the digital model 210 may be formed along a curved surface and thus, a transition area may exist between the set of digital tiles 216 and a portion of the recess 302. In some examples, the processor 202 may modify at least one of the digital tile 216 and the 3D part 300 to reduce or minimize a sharpness of the transition area, for instance, by introducing additional features to the digital tiles 216 to make the transition area smoother. In another example, the processor 202 may make the recess 302 larger and may smoothly blending the geometry between the straight sides of the digital tiles 216 and the irregular sides of the recess 302.

The computer-readable medium 100 may include instructions 112 that may cause the processor 202 to generate a digital representation 218 of the modified digital model 212 and the added set of digital tiles 216. According to examples, the digital representation 218 may maintain the added set of digital tiles 216 and the digital model 210 as separately meshed elements. In other words, the processor 202 may not process, e.g., mesh, or the like, the digital representation 218 such that the added set of digital tiles 216 may remain as separately meshed files from the mesh of the digital model 210. As a result, the processor 202 may not consume additional compute resources to mesh the digital representation 218.

The processor 202 may display the digital representation 218 such that a user may view the digital representation 218 and may determine whether any changes are to be made to the recess 302 and/or the set of digital tiles 216. If instructed to do so, the processor 202 may modify the set of digital tiles 216 and may generate another digital representation 218 with the modified recess 302 and/or the set of digital tiles 216.

The computer-readable medium 100 may further include instructions that may cause the processor 202 to output the generated digital representation 218. For instance, the processor 202 may output the generated digital representation 218 to a 3D fabrication system (not shown). In some examples, the processor 202 may output the generated digital representation 218 as a file to the 3D fabrication system and the 3D fabrication system may fabricate the 3D part 300 with the set of digital tiles 216. In other examples, the processor 202 may output the generated digital representation 218 to control the 3D fabrication system to fabricate the 3D part 300 with the set of digital tiles 216 using the generated digital representation 218.

In any of the examples discussed herein, fabrication components in the 3D fabrication system (not shown) may fabricate the 3D part 300 with the set of digital tiles 216 according to the generated digital representation 218. The 3D fabrication system, which may be an additive manufacturing system, may fabricate the 3D part 300 and the set of digital tiles 216 from any suitable type of material such as thermoplastic urethane, polyether block amide, and/or the like. In some examples, the fabrication components of the 3D fabrication system may selectively apply a binding agent onto build material powder to fabricate the 3D part 300 and the set of digital tiles 216. In addition or alternatively, the fabrication components may include an energy source that may selectively apply energy onto build material powder to fabricate the 3D part 300 and the set of digital tiles 216. The fabrication components may alternatively include other types of components that may fabricate the 3D part 300 and the set of digital tiles 216 through an additive manufacturing technique.

According to examples, the computer-readable medium 100 may include instructions that may cause the processor 202 to generate additional digital representations of the digital model 210 with respective sets of digital tiles 216, in which the sets of digital tiles 216 may differ with respect to each other. For instance, the sets of digital tiles 216 may each represent a particular content 214, such as a particular serial number, a particular identifier, a particular name, a particular date, and/or the like. In these examples, the processor 202 may generate the multiple digital representations 218 without modifying the digital model 210 to add the sets of digital tiles 216 to the digital model 210. Instead, the processor 202 may modify the digital model 210 a limited number of times, e.g., one time, to include the recess 302 into which the sets of digital tiles 216 may be inserted.

Particularly, for instance, the computer-readable medium 100 may include instructions that may cause the processor 202 to access a digital model 210 of a 3D part 300, in which the digital model 210 includes a recess 302 corresponding to a cutout to be formed in the 3D part 300. In some examples, the accessed digital model 210 of the 3D part 300 may include the recess 302 and thus, the processor 202 may not add the recess 302. In other examples, the processor 202 may modify the digital model 210 to add the recess 302 to the digital model 210. In these examples, the processor 202 may apply an operation on the modified digital model 212 to render the modified digital model 212 to be ready for a 3D fabrication system to fabricate the 3D part 300 using the modified digital model 212 as discussed herein.

In any of these examples, the processor 202 may identify sets of variable content 214 to be added to the cutout in the 3D part 300, in which each of the variable content 214 may include a respective set of characters that are to be visible on the 3D part 300. The content 214 may be variable in that the content 214 may change for some or all of multiple 3D parts 300. By way of particular example, the content 214 may be incremented each time the content 214 is used for a 3D part 300. In this example, the information identified by the digital tiles 216 may be used to control the number of instances at which a particular part 300 is printed, for instance, for rights managed printing of multiple parts 300.

The processor 202 may also access sets of digital tiles 216 that include characters corresponding to the sets of variable characters in the sets of variable content 214 and may add the accessed sets of digital tiles 216 into the recesses 302 of respective ones of the digital model 210. The processor 202 may further generate digital representations 218 of the digital model 210, in which each of the generated digital representations 218 includes a respective set of digital tiles 216 in the recess 302 of the digital model 210, and in which each of the generated digital representations 218 may maintain the respective set of digital tiles 216 and the digital model 210 as separately meshed elements.

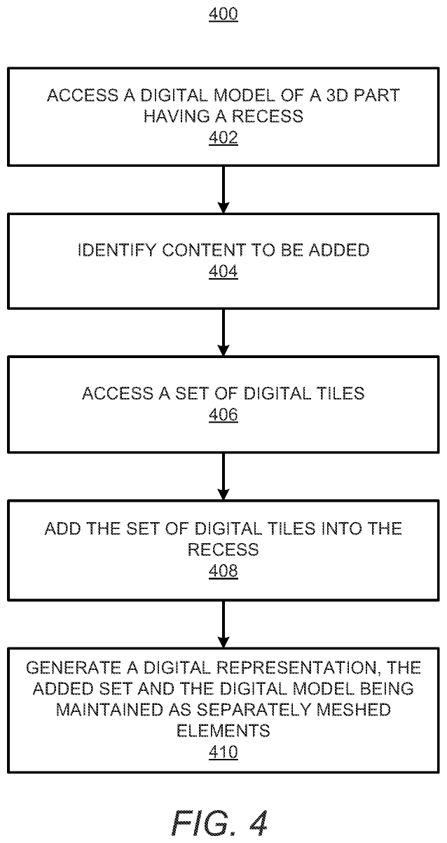

Various manners in which a processor 202 may execute the instructions 102-112 are discussed in greater detail with respect to the method 400 depicted in FIG. 4. Particularly, FIG. 4 depicts a flow diagram of an example method 400 for generating a digital representation 218 of a digital model 210 and an added set of digital tiles 216 in a recess 302 of the digital model 210. It should be understood that the example method 400 may include additional operations and that some of the operations described herein may be removed and/or modified without departing from the scope of the method 400. The description of the method 400 is made with reference to the features depicted in FIGS. 1-3 for purposes of illustration.

At block 402, the processor 202 may access a digital model 210 of a 3D part 300, in which the digital model 210 may include a recess 302 corresponding to a cutout to be formed in the 3D part 300. In some examples, the processor 202 may access the digital model 210 with the recess 302, while in other examples, the processor 202 may modify the digital model 210 to include the recess 302. In the latter examples, the processor 202 may apply an operation on the modified digital model 212 to render the modified digital model 212 to be ready for a 3D fabrication system to fabricate the 3D part 300 using the modified digital model 212.

At block 404, the processor 202 may identify content 214 to be added to the cutout in the 3D part 300, in which the content 214 may include a set of characters that are to be visible on the 3D part 300. At block 406, the processor 202 may access a set of digital tiles 216 that may include characters corresponding to the set of characters included in the identified content 214. As discussed herein, the processor 202 may modify the set of digital tiles 216 such that the set of digital tiles 216 is slightly larger than the recess 302. In addition, or alternatively, the processor 202 may access a first digital tile 216 corresponding to a first character in the set of characters from a first group of digital tiles 216 and may access a second digital tile 216 corresponding to a second character in the set of characters from a second group of digital tiles 216. In these examples, the digital tiles 216 in the first group of digital tiles 216 may include digital tiles 216 that have properties that differ from the digital tiles 216 in the second group of digital tiles 216.

At block 408, the processor 202 may add the accessed set of digital tiles 216 into the recess 302 of the digital model 210. In addition, at block 410, the processor 202 may generate a digital representation 218 of the digital model 210 and the added set of digital tiles 216 in the recess 302 of the digital model 210. As discussed herein, the processor 202 may maintain the added set of digital tiles 216 and the digital model 210 in the digital representation 218 as separately meshed elements.

As discussed herein, the processor 202 may generate additional digital representations 218 of the digital model 210 with respective sets of digital tiles 216, in which the sets of digital tiles 216 may differ with respect to each other. Thus, for instance, the processor 202 may identify second content 214 to be added to a second 3D part 300 and may access a second set of digital tiles 216 corresponding to the second content 214. The second content 214 may include a second set of characters that are to be visible on the 3D part 300 and may differ from the set of characters in the content 214 used for a previously generated digital representation 218. The processor 202 may also add the accessed second set of digital tiles 216 corresponding to the second content 214 into the recess 302 in the digital model 210 and may generate a second modified digital representation 218 of the 3D part 300 and the accessed second set of digital tiles 216 in the recess 302 of the digital model 210.

The processor 202 may further output the digital representation(s) 218 to a 3D fabrication system and the 3D fabrication system may fabricate the 3D part(s) 300 according to the digital representation(s) 218.

Some or all of the operations set forth in each of the method 400 may be included as utilities, programs, or subprograms, in any desired computer accessible medium. In addition, the method 400 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A non-transitory computer-readable medium on which is stored machine-readable instructions that when executed by a processor, cause the processor to:
access a digital model of a three-dimensional (3D) part;
modify the digital model to add a recess to the digital model, wherein the recess corresponds to a cutout to be formed in the 3D part;
identify content to be added to the 3D part, wherein the content is to be visible on the 3D part;
access a set of digital tiles corresponding to the identified content;
add the accessed set of digital tiles corresponding to the identified content into the recess in the modified digital model; and
generate a digital representation of the modified digital model and the added set of digital tiles, wherein the digital representation maintains the added set of digital tiles and the digital model as separately meshed elements.

2. The non-transitory computer-readable medium of claim 1, wherein the digital model of the 3D part comprises a print-ready model of the 3D part and wherein the digital representation comprises a print-ready model of the 3D part and the set of digital tiles.

3. The non-transitory computer-readable medium of claim 1, wherein the instructions further cause the processor to:
identify second content to be added to the 3D part;
access a second set of digital tiles corresponding to the second content;
add the accessed second set of digital tiles corresponding to the second identified content into the recess in the digital model; and
generate a second digital representation of the 3D part and the accessed second set of digital tiles in the recess of the digital model.

4. The non-transitory computer-readable medium of claim 1, wherein the set of digital tiles have a first width and a first height, and wherein the instructions further cause the processor to:
modify the digital model to add the recess to have a second height and a second width, wherein the second height is smaller than the first height and the second width is smaller than the first width.

5. The non-transitory computer-readable medium of claim 1, wherein the instructions further cause the processor to:
access the set of digital tiles corresponding to the identified content from a library of digital tiles.

6. The non-transitory computer-readable medium of claim 1, wherein the identified content comprises a set of characters and wherein the instructions further cause the processor to:
access a first digital tile corresponding to a first character in the content from a first group of digital tiles; and
access a second digital tile corresponding to a second character in the content from a second group of digital tiles, wherein the digital tiles in the first group of digital tiles comprise digital tiles that have properties that differ from properties of the digital tiles in the second group of digital tiles.

7. The non-transitory computer-readable medium of claim 1, wherein the instructions further cause the processor to:
scale the accessed set of digital tiles to be sized to fit into the recess.

8. The non-transitory computer-readable medium of claim 1, wherein the instructions further cause the processor to:
identify a transition area between a digital tile in the recess and a portion of the recess; and
modify at least one of the digital tile and the 3D part to reduce or minimize a sharpness of a transition between the digital tile and the portion of the recess in the transition area.

9. A method comprising:
accessing, by a processor, a digital model of a three-dimensional (3D) part, wherein the digital model includes a recess corresponding to a cutout to be formed in the 3D part;
identifying, by the processor, content to be added to the cutout in the 3D part, wherein the content includes a set of characters that are to be visible on the 3D part;
accessing, by the processor, a set of digital tiles comprising characters corresponding to the set of characters included in the identified content;
adding, by the processor, the accessed set of digital tiles into the recess of the digital model; and
generating, by the processor, a digital representation of the digital model and the added set of digital tiles in the recess of the digital model, wherein the added set of digital tiles and the digital model are maintained in the digital representation as separately meshed elements.

10. The method of claim 9, further comprising:
modifying the digital model of the 3D part to add the recess to the digital model; and
applying an operation on the modified digital model to render the modified digital model to be ready for a 3D fabrication system to fabricate the 3D part using the modified digital model.

11. The method of claim 9, further comprising:
identifying second content to be added to a second 3D part;
accessing a second set of digital tiles corresponding to the second content, wherein the second content includes a second set of characters that are to be visible on the 3D part and differ from the set of characters;
adding the accessed second set of digital tiles corresponding to the second content into the recess in the digital model; and
generating a second modified digital representation of the 3D part and the accessed second set of digital tiles in the recess of the digital model.

12. The method of claim 9, wherein the recess has a first height and a first width, and wherein the method further comprises:
modifying the set of digital tiles to have a second height and a second width, wherein the second height is larger than the first height and the second width is larger than the first width.

13. The method of claim 9, further comprising:
accessing a first digital tile corresponding to a first character in the set of characters from a first group of digital tiles; and
accessing a second digital tile corresponding to a second character in the set of characters from a second group of digital tiles, wherein the digital tiles in the first group of digital tiles comprise digital tiles that have properties that differ from the digital tiles in the second group of digital tiles.

14. An apparatus comprising:
a processor; and
a memory on which is stored instructions that when executed by the processor, cause the processor to:
access a digital model of a three-dimensional (3D) part, wherein the digital model includes a recess corresponding to a cutout to be formed in the 3D part;
identify sets of variable content to be added to the cutout in the 3D part, wherein each of the variable content includes a respective set of characters that are to be visible on the 3D part;
access sets of digital tiles comprising characters corresponding to the sets of variable characters in the sets of variable content;
add the accessed sets of digital tiles into the recesses of respective ones of the digital model; and
generate digital representations of the digital model, wherein each of the generated digital representations includes a respective set of digital tiles in the recess of the digital model, and wherein each of the generated modified digital representations maintains the respective set of digital tiles and the digital model as separately meshed elements.

15. The apparatus of claim 14, further comprising:
modify the digital model to add the recess to the digital model; and
apply an operation on the modified digital model to render the modified digital model to be ready for a 3D fabrication system to fabricate the 3D part using the modified digital model.
